(19) United States
(12) Patent Application Publication
(10) Pub. No.: US 2007/0286983 A1
(43) Pub. Date: Dec. 13, 2007

(54) Bumper slicker

(76) Inventors: Diana Trimble, New York, NY (US); William Edward Jones, New York, NY (US)

Correspondence Address: Diana Trimble, 1763 Second Avenue 17G, New York, NY, 10128, US

(21) Appl. No.: 11/263,376

(22) Filed: Jun. 13, 2006

(51) Int. Cl. B32B 3/06

(52) U.S. Cl. 428/99

(57) ABSTRACT

The Bumper Slicker is: 1.) A magnetic frame for displaying bumper stickers or other similar communications on cars and other vehicles. The frame can come in any color or imprinted with a logo or graphics and can be placed or removed from any metal area of the vehicle in seconds. 2.) The magnetic frame is attached to a flexible, sealible/resealible weatherproof window/pocket made of durable material in which the bumper sticker or other communication can easily be inserted and removed. Traditional adhesive bumper stickers are hard or impossible to completely remove; the Bumper Sticker allows one to display or remove a bumper sticker or other similar communication in seconds. It can be placed on any metal part of a vehicle without any special mounting holes or devices, screws or clips. The sealible/resealible window flap allows for quick change or removal of bumper stickers or other similar communications.

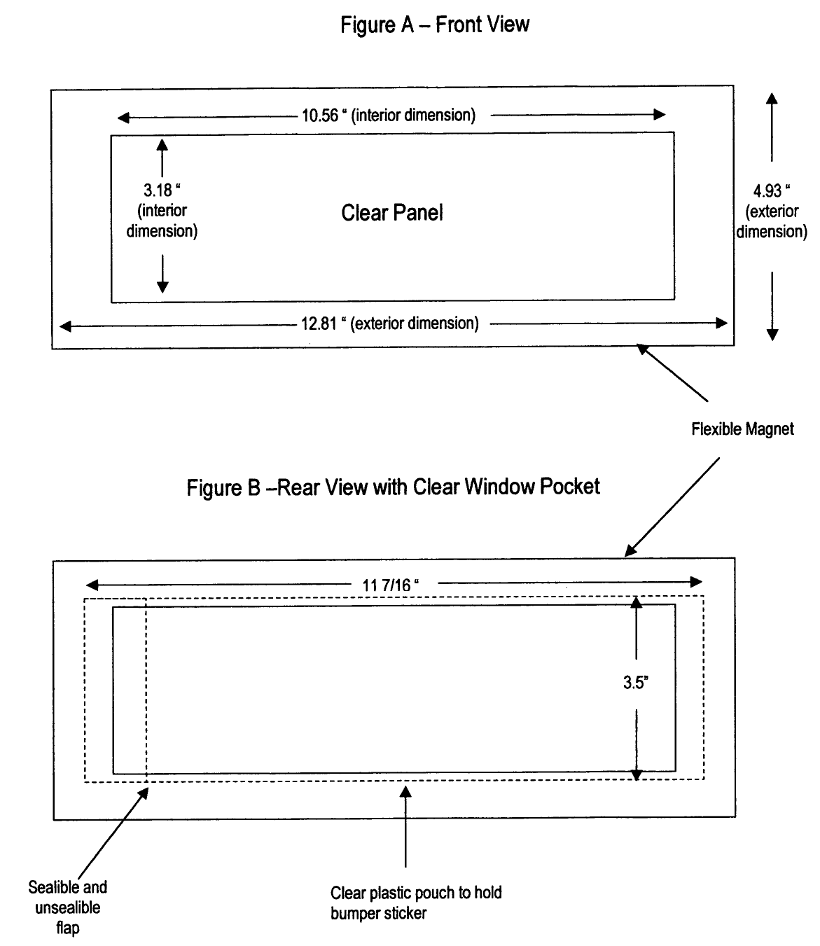

### CROSS-REFERENCE TO RELATED APPLICATIONS

Ser. No. 11/263,376

### STATEMENT REGARDING FEDERALLY SPONSORED RESEARCH OR DEVELOPMENT

Not Applicable

### REFERENCE TO SEQUESNT LISTING, A TABLE, OR A COMPUTER PROGRAM LISTING COMPACT DISC APPENDIX

Not Applicable

### BACKGROUND OF THE INVENTION

Magnets have become more and more common on cars, vans, trucks and other modes of ground transportation, especially the yellow patriotic Support Our Troops ‘ribbons’, pink Find the Cure ‘ribbons’ and the like. One day, Ms. West decided to take one of the Support Our Troops ribbons, put a clear plastic cover over it and insert a photo of someone dear to her in the space created by the “loop” in the ‘ribbon.’ It occurred to her that this idea could easily be adapted into a “frame” large enough to accommodate a bumper sticker or other picture a driver may want to display on their vehicle without necessarily having to put a large, difficult-to-remove sticker directly on their car. Mr. Jones, an electrical engineer with a background in technical drawing, came up with the diagram and dimensions to accommodate at least a bumper-sticker sized media, primarily made of paper or other lightweight material (such as a bumper sticker) that would be held in place by the magnet frame and protected by a clear,flexible weatherproof window. Any standard-sized bumper sticker would be able to fit in the magnetized frame. It is a completely non-permanent way for drivers to display bumper stickers without having to put the adhesive backing directly on your car, potentially ruining the finish when trying to scrape it off, or looking unsightly as it ages and deteriorates due to the elements and age.

### BRIEF SUMMARY OF THE INVENTION

The Bumper Slicker is a frame made out of a strong, flexible, weatherproof magnet that adheres directly to anywhere on a car, truck, or other metallic part of a vehicle's body. Attached to the frame is a clear, flexible weatherproof window which allows for a bumper sticker or other form of written or visual communication not only be seen by other drivers, but to be inserted or removed easily by the owner. This allows the bumper sticker or other form of communication to be changed, removed or replaced as the vehicle owner wishes, as opposed to a traditional bumper sticker with sticky, hard-to-remove adhesive backing that often must be scraped off when the person no longer wants to display the bumper sticker. The magnetic frame allows the device to be applied and removed at will. No installation, drilling or pre-existing mounting holes are required for it to stay on the body of the vehicle. The device does not require anything to be screwed in or clipped or snapped on. It is simply placed on and off in seconds like a magnet. This is advantageous over traditional bumper stickers where vehicle owners may not want to put a semi-permanent adhesive backing directly on to their vehicle or other mount other frame-type devices with mounting holes, screws, rivets or the like. The Bumper Slicker is simply comprised of a.) flexible, magnetized frame and b.) clear, weatherproof, flexible window to protect the bumper sticker or other media.

### BRIEF DESCRIPTION OF THE SEVERAL VIEWS OF THE DRAWING

FIGURE A—FRONT VIEW: Main frame is composed of a long rectangle with an exterior length of 12.81 inches (top and bottom) and 4.93 inches high each exterior side. Interior dimensions are length of 10.56 inches long top and bottom and 3.18 inches wide each interior side. Surface area on all sides can be either left plain or imprinted with numbers, letters, words, or symbols for the owner to personalize or for promotional purposes. Standard car colors (silver, red, etc.) as annual automotive surveys indicate or as ordered by potential owners may be used.

FIGURE B—REAR VIEW; Attached to the back of the frame is a clear, weatherproof flexible “pocket” of appropriate material. The pocket is 11 and 7/16^{th} inches long (top and bottom) and 3 and one-half inches high. There is flap which opens, closes and seals, allowing for the insertion and removal of a standard-sized bumper stickers. The pocket protects the bumper sticker or other media from the elements and normal wear-and-tear.

### DETAILED DESCRIPTION OF THE INVENTION

Figure A shows the front view of the Bumper Slicker. It is a frame made out of a magnet or magnet-like material intended for use on a car or other ground transportation vehicle with a clear flexible plastic or other suitable, clear window through which a bumper sticker can be inserted and viewed.

Figure A exterior dimensions of the top and bottom sides (length) of the frame are 12.81 inches.

Figure A interior dimensions (length) are 10.56 inches.

Figure A interior dimensions (height) is 3.18 inches.

Figure B shows the back view of the Bumper Slicker and the dimensions of the flexible, clear-view pocket. The clear-view pocket will be made of weatherproof material and affixed on the rectangular magnetic frame in a way most effective for sealing out rain, snow, and other outdoor elements to protect the bumper sticker or other media inserted within it.

Figure B shows the dimensions of the clear-view pocket which lengthwise measures 11 by 1/16 inches at the top and bottom

Figure B shows the dimensions of the clear-view pocket with a height of 3.5 inches.

Figure B describes the clear-view pocket as a clear plastic pouch to hold a bumper sticker or other form of communication inserted in the pocket for display.

Figure B shows a sealible flap through which a bumper sticker is easily inserted and removed.

The flexible nature of both the magnet and the clear plastic weatherproof pocket/pouch allow for the Bumper Slicker to be affixed on any metal area of a car or other ground transportation vehicle (metal part of bumper, trunk, hood, side, door, etc.)

The Bumper Slicker can be imprinted with any kind of logo, insignia, etc. during the manufacturing process and is easily customizable and adaptable according to desire use: advertising, promotions, or just communication of views. By way of example: a school may want to purchase and imprint Bumper Slicker frames with “John F. Kennedy High School” on the top part of the exterior frame and “Class of 1987 Reunion” on the bottom part of the exterior frame. Bumper stickers inserted into the Bumper Slicker device can be of any type, regardless of what the Bumper Slicker frame itself says. Most importantly, by simply removing the magnetic Bumper Slicker frame from the vehicle, turning it over, taking out the old bumper sticker, inserting a new one and attaching the Bumper Slicker back on, the driver can change their message in seconds.

In addition to customized logos, the Bumper Slicker can come in a variety of colors, including standard popular car colors for those who want just the frame without a logo so it blends in with the car and the bumper sticker itself is most prominent.

1.) The Bumper Slicker is a flexible, magnetic frame, slightly larger than the size and dimension of standard bumper stickers, combined with a clear, flexible weatherproof pocket that can be attached to any metallic surface on a car or other ground transportation vehicle.

2.) The clear pocket seals and unseals, offering drivers the ability to display and change bumper stickers or other similar forms of communication whenever desired.
